(19) United States
(12) Patent Application Publication
(10) Pub. No.: US 2009/0061148 A1
(43) Pub. Date: Mar. 5, 2009

(54) AUXILIARY MAT FOR VEHICLE

(76) Inventor: Seung Kwon Cha, Suwon-si (KR)

Correspondence Address: MORGAN, LEWIS & BOCKIUS LLP (SF), One Market, Spear Street Tower, Suite 2800, San Francisco, CA, 94105, US

(21) Appl. No.: 11/959,768

(22) Filed: Dec. 19, 2007

(30) Foreign Application Priority Data
Aug. 28, 2007 (KR) 10-2007-0086596

(51) Int. Cl. B32B 33/00

(52) U.S. Cl. 428/95

(57) ABSTRACT

An auxiliary mat for a vehicle includes a carpet layer forming an upper surface of the auxiliary mat; a pad integrally formed on a lower surface of the carpet layer; an inner edge projectedly formed to delimit a periphery of the pad and to be inserted into a floor carpet which is located under the pad, and defining a concave groove adjacent thereto; a plurality of reinforcing ribs integrally projecting downward from a place adjacent to the pad in the concave groove defined outwards along the inner edge to maintain the shape of the inner edge; and an outer edge formed along an outer end of the carpet layer.

### CROSS-REFERENCE TO RELATED APPLICATIONS

This application claims priority to Korean Application No. 10-2007-0086596, filed on Aug. 28, 2007, the disclosure of which is incorporated herein by reference.

### BACKGROUND OF THE INVENTION

1. Field of the Invention

The present invention relates to an auxiliary mat used on a floor panel in the cabin of a vehicle, and, more particularly, to an auxiliary mat for a vehicle, which can be manufactured at a reduced cost and the weight of which can be decreased.

2. Description of the Related Art

As is well known to those skilled in the art, a floor carpet is installed on a floor panel in the cabin of a vehicle. In order to prevent the floor carpet from being soiled, an auxiliary mat is placed on the floor carpet.

Referring to FIG. 1, the auxiliary mat 100 includes a pad 105, which is made of soil PVC or crude rubber, and a carpet layer 110, which is bonded onto the pad 105.

A peripheral part 120 for reinforcing the strength of the auxiliary mat 100 is formed around the distal edge of the auxiliary mat 100. A plurality of protuberances 105a for preventing the auxiliary mat 100 from slipping is formed on the lower surface of the pad 105.

Specifically, the peripheral part 120 protrudes upward to be corrugated in the shape of a wave. In this regard, in order to maintain the protruding shape of the peripheral part 120, a reinforcing member 125 is attached to the lower surface of the peripheral part 120. The reinforcing member 125 is made of a relatively hard material, such as plastic or wood, to prevent the protruding shape of the peripheral part 120 from being deformed by external force.

However, in the conventional auxiliary mat 100 for a vehicle, since different materials are used for the pad 105 and the reinforcing member 125, the material cost increases, and since an additional process for bonding these two elements to each other is required, the manufacturing cost increases. Also, the overall weight of the auxiliary mat 100 increases due to the attachment of the reinforcing member 125.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made keeping in mind the above problems occurring in the prior art, and the present invention is intended to propose an auxiliary mat for a vehicle in which the pad, arranged on the lower pail of the auxiliary mat is formed only of rubber, and no additional material, such as plastic or wood, is used, so that the manufacturing cost is decreased and the price competitiveness of the auxiliary mat is improved.

Another object of the present invention is to provide an auxiliary mat for a vehicle which can be manufactured to be decreased in weight, thereby contributing to the improvement of the fuel economy of the vehicle.

In order to achieve the above objects, according to one aspect of the present invention, there is provided an auxiliary mat for a vehicle, comprising a carpet layer forming an upper surface of the auxiliary mat; a pad integrally formed on the lower surface of the carpet layer; an inner edge projectedly formed to delimit the lower periphery of the pad and be inserted into a floor carpet which is located under the pad, and defining a concave groove adjacent thereto; at least a reinforcing rib wherein a proximate end portion of the reinforcing ribs are positioned substantially near to the inner edge of the pad and a distal end portion of the reinforcing ribs integrally extends downward along the contour of the concave groove to the outer edge portion of the carpet layer to maintain a shape of the inner edge of the pad; and an outer edge formed along the outer end of the carpet layer.

According to another aspect of the present invention, the reinforcing ribs have a structure in which they repeatedly project to define semicircular patterns.

According to another aspect of the present invention, the reinforcing ribs further comprises at least a supporting frame to support, semicircular patterns.

According to another aspect of the present invention, lower ends of the reinforcing ribs are flush with a lower end of the inner edge of the pad.

According to another aspect of the present invention, the semicircular pattern frames of the reinforcing ribs are formed to have a structure in which they partially overlap one another.

According to another aspect of the present invention, wherein a lower end of the outer edge of the carpet layer is positioned lower than the lower end of the inner edge of the pad so that the outer edge can be inserted deeper than the inner edge into the floor carpet, which is located under the pad.

According to another aspect of the present invention, the reinforcing ribs have a structure in which they repeatedly project to define semicircular patterns.

According to another aspect of the present invention, the semicircular pattern frames of the reinforcing ribs are formed to have a structure in which they partially overlap one another.

According to another aspect of the present invention, the lower end of the outer edge is positioned lower than the lower end of the inner edge, so that the outer edge can be inserted deeper than the inner edge into the floor carpet which is located under the pad.

According to another aspect of the present invention, the reinforcing ribs have a structure in which a height of the semicircular pattern frames is highest adjacent to the inner edge of the pad and gradually decreases toward the outer edge of the carpet layer.

According to still another aspect of the present invention, the reinforcing ribs are formed to have a quadrangular, triangular or angled sectional shape to be inserted into the floor carpet and be securely held therein against slippage.

According to a still further aspect of the present invention, the inner edge and the outer edge have sharp corners.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration, and thus are not limitative of the present invention, and wherein:

FIG. 1 is a cross-sectional view illustrating a conventional auxiliary mat for a vehicle;

FIG. 2 is a bottom view illustrating an auxiliary mat for a vehicle in accordance with an exemplary embodiment of the present invention;

FIG. 3 is an enlarged perspective top view removing a floor carpet, illustrating the reinforcing ribs formed in the auxiliary mat for a vehicle according to the present invention;

FIGS. 4A through 4D are views illustrating the reinforcing ribs formed in the auxiliary mat for a vehicle according to the present invention, wherein FIG. 4A is a bottom view of the reinforcing ribs, FIG, 4B is a cross-sectional side view taken along the line A-A of FIG. 4A, FIG. 4C is a cross-sectional side view taken along the line B-B of FIG. 4A, and FIG. 4D is a cross-sectional side view taken along the line C-C of FIG. 4A; and

FIG. 5 is a cross-sectional side view illustrating the state in which the auxiliary mat for a vehicle according to the present invention is placed on a floor carpet.

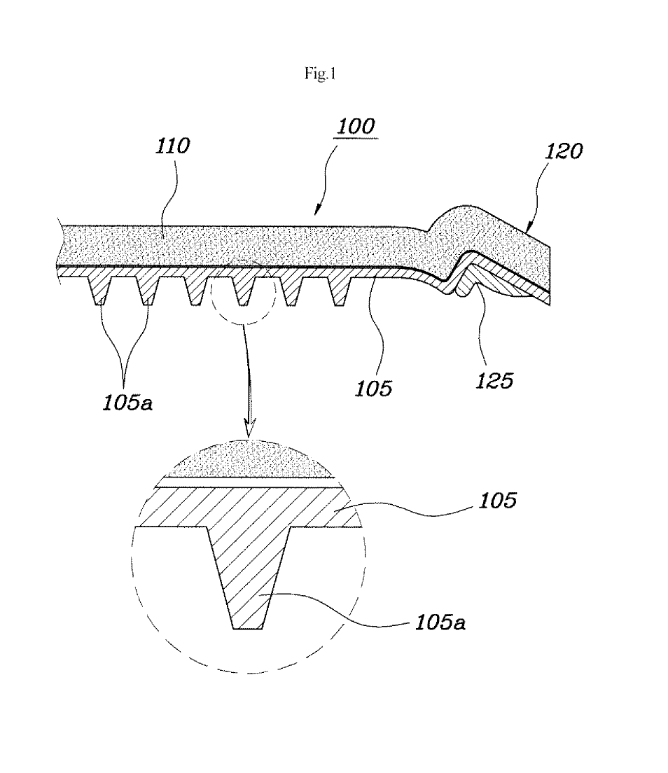

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF THE PREFERRED EMBODIMENTS

Reference will now be made in detail to a preferred embodiment of the present invention, an example of which is illustrated in the accompanying drawings and described below. While the invention will be described in conjunction with an exemplary embodiment, it should be understood that the description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

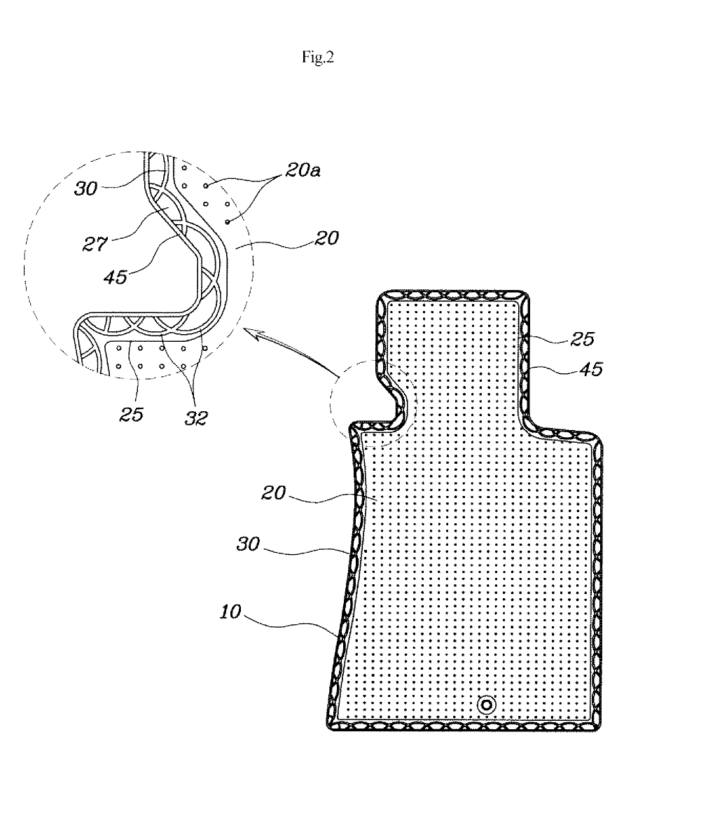

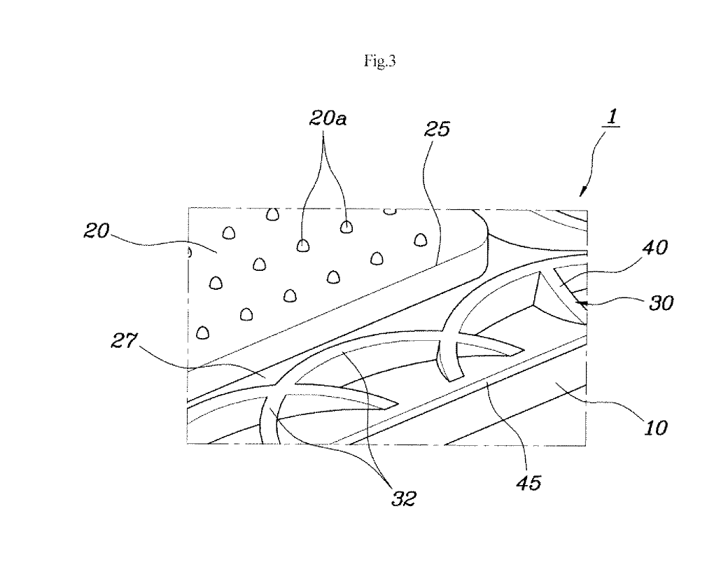

An auxiliary mat 1 for a vehicle in accordance with an exemplary embodiment of the present invention is intended to be used on the floor panel 70 of a vehicle. Referring to FIGS. 2 and 3, the auxiliary mat 1 includes a carpet layer 10, which covers the upper surface of a pad 20 and reinforcing ribs 30 wherein the pad 20 and the reinforcing ribs 30, are integrally formed on the lower surface of the carpet layer 10.

The pad 20 is configured to have a plurality of protuberances 20a, which protrudes from the lower surface of the pad 20, as in the conventional art, so that the auxiliary mat 1 is prevented from slipping on a floor carpet 60, which is located under the pad 20, and from changing in the position thereof. The floor carpet 60 may be placed on the upper surface of the floor panel 70 as shown in FIG. 5.

For the sake of convenience in explanation, FIG. 2 illustrates a bottom view which is obtained by viewing the auxiliary mat 1 for the vehicle according to the present invention from beneath, in which the carpet layer 10 is positioned downward and the pad 20 is positioned upward.

Referring to FIG. 3, the pad 20 of the auxiliary mat 1 for a vehicle according to the present invention has an inner edge 25 protruded from the edge along the lower periphery of the pad 20. The inner edge 25 of the pad 20 is inserted into the floor carpet 60 of the vehicle, which is disposed under the pad 20.

The inner edge 25 of the pad 20 is configured to have a sharp corner so that the inner edge 25 can be easily inserted into a portion of the floor carpet 60 of the vehicle.

Furthermore, the carpet layer 10 includes an outer edge 45 formed at the distal lower end portion of the carpet layer 10 wherein the outer edge 45 is protruded along the lower periphery of the distal lower end portion of the carpet layer 10.

The outer edge 45 of the carpet layer 10 is structured to have a sharp corner so that the outer edge 45 can be easily inserted into a portion of the floor carpet 60 of the vehicle which is located at a distal portion of the carpet layer 10.

A concave groove 27 is defined between the inner edge 25 of the pad 20 and the outer edge 45 of the carpet layer 10.

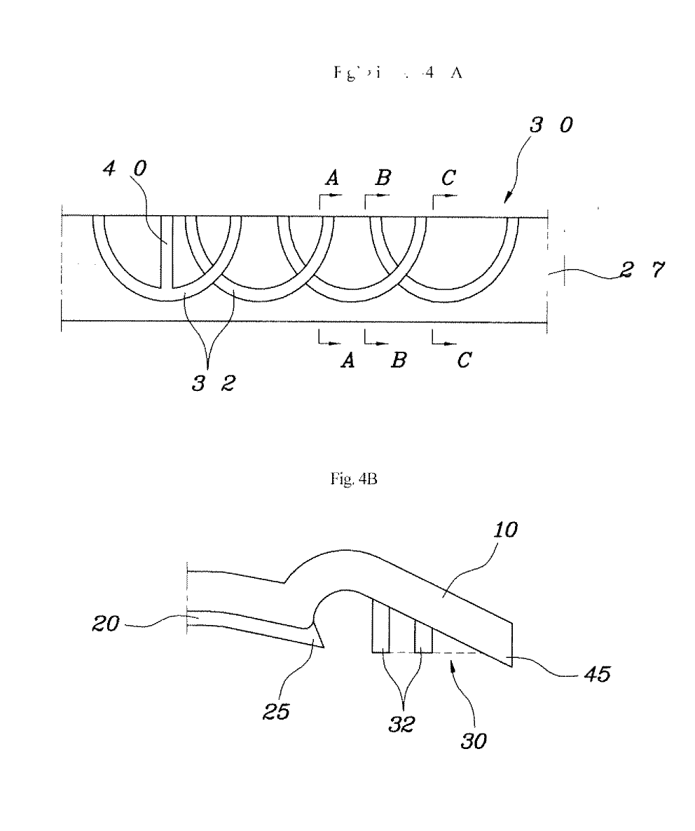

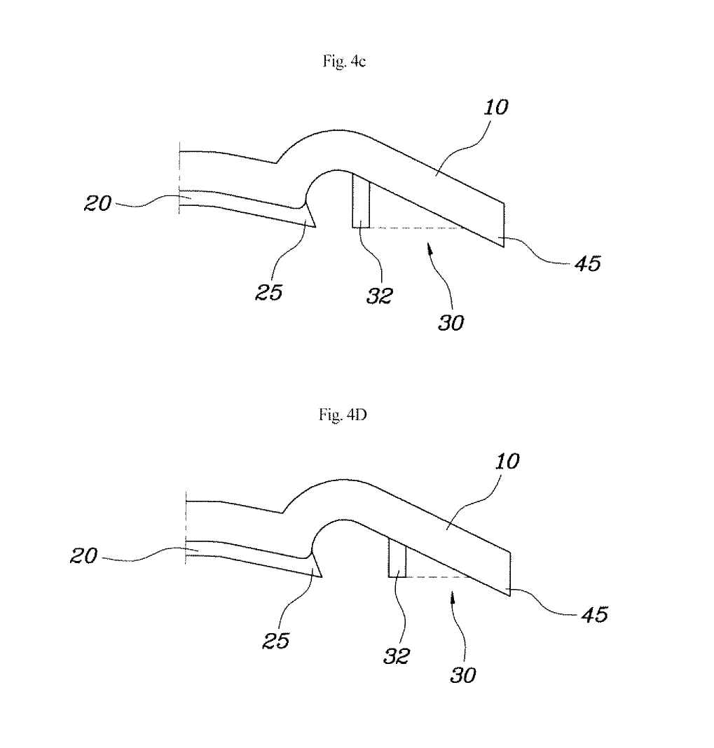

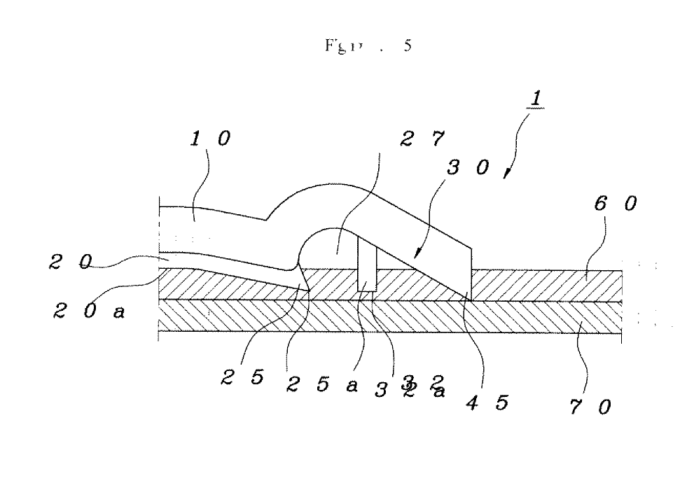

As shown in FIGS. 3, 4A and 4B, the auxiliary mat 1 for a vehicle according to an exemplary embodiment of the present invention further includes reinforcing ribs 30 comprising at least a semicircular pattern frame 32 and at least a supporting frame 40. The reinforcing ribs 30 are placed around the pad 20 between the carpet layer 10 and the floor carpet 60.

In detail, the semicircular pattern frames 32 of the reinforcing ribs 30 are positioned between the inner edge 25 of the pad 20 and the outer edge 45 of the carpet layer 10 and integrally extends outwards with a slope inclined downward to a portion substantially near to the outer edge 45 of the carper layer 10.

The semicircular pattern frames 32 may be partially overlapped one another in a manner such that the lower ends 32a of the respective semicircular pattern frames 32 are substantially flush with the lower end 25a of the inner edge 25 of the pad 20.

The reinforcing ribs 30 are formed in a manner such that respective semicircular pattern frames 32 partially overlap with each other, for example, over the range corresponding to ⅓ or ¼ of the width of the semicircular pattern frames 32. The overlapping regions, in which the semicircular pattern frames 32 are connected by partially overlapping one another, can disperse and effectively resist: external force when the external force is applied to the portion of the auxiliary mat 1 that defines the concave groove 27.

The supporting frame 40 of the reinforcing ribs 30 may be positioned at the middle portion of the semicircular pattern frame 32 and integrally extends outwards with a slope inclined downward from the semicircular pattern frames 32 to a portion substantially near to the outer edge 45 of the carper layer 10 so as to maintain the sectional shape of the concave groove 27 unchanged.

However, in an exemplary embodiment of the present invention, the supporting frame 40 of the reinforcing ribs 30 may integrally extends inwards to the pad 20 so as to maintain the sectional shape of the concave groove 27 unchanged.

The reinforcing ribs 30 are formed of the same rubber material as the pad 20 and extend downward.

Since the lower ends 32a of the semicircular pattern frames 32 and the lower ends (not shown) of supporting frame 40 are substantially flush with the lower end 25a of the inner edge 25 of the pad 20, even when external force is applied to the portion of the auxiliary mat 1 that defines the concave groove 27, the portion is prevented from being pressed downward and the sectional shape of the concave groove 27 can be maintained unchanged, as a result of which the inner edge 25 can maintain the original shape thereof.

Furthermore, the reinforcing ribs 30 function to maintain the original shape of the inner edge 25 of the pad 20 and protect it from external forces by means of the respective semicircular pattern frames 32 and supporting frames 40.

The semicircular pattern frames 32, which are connected by partially overlapping one another, are regularly and repeatedly formed along the concave groove 27 to stably maintain the shape of the portion of the auxiliary mat 1 which defines the concave groove 27.

In the present invention, the reinforcing ribs 30 are formed to have a structure in which the height of the semicircular pattern frames 32 is greatest adjacent to the inner edge 25 of the pad 20 and gradually decreases toward the outer edge 45 of the auxiliary mat 1. Therefore, since the semicircular pattern frames 32 are formed along the sectional shape of the concave groove 27 such that the lower ends 32a of the semicircular pattern frames 32 are flush with the lower end 25a of the inner edge 25, external force is not concentrated to the portion of the concave groove 27, but is supported by the lower end 25a of the inner edge 25 of the pad 20, the lower ends 32a of the semicircular pattern frames 32, and the bottom portion of the supporting frame 40, which are positioned at the same level, so that the portion of the concave groove 27 is prevented from being deformed by external forces.

The reinforcing ribs 30 can be formed to have a quadrangular, triangular or angled sectional shape. The present invention covers all of these and other sectional shapes.

Through the above-described construction, the auxiliary mat 1 can be securely held against slippage on the floor carpet 60.

As described above, the auxiliary mat 1 according to the present invention has an outer edge 45 which is formed on the outer periphery of the carpet layer 10. The lower end of the outer edge 45 of the carpet layer 10 is positioned lower than the inner edge 25 of the pad 20 so that the outer edge 45 can be deeply inserted into the floor carpet 60 which is disposed under the pad 20.

The outer edge 45 of the carpet layer 10 delimits the outermost perimeter of the auxiliary mat 1 for a vehicle according to the present invention and is formed to be deeply inserted into the floor carpet 60 which is located under the pad 20. As the outer edge 45 of the carpet layer 10 has a sharp corner, the outer edge 45 of the carpet layer 10 can be easily and stably positioned in the floor carpet 60 which is located under the pad 20.

The unexplained reference numeral 70 designates a floor panel, which is arranged under the floor carpet 60 and is made of a hard material such as metal.

When the auxiliary mat 1 for a vehicle according to the present invention, constructed as mentioned above, is positioned in place in the vehicle, as shown in FIG. 5, the inner edge 25 of the pad 20, the reinforcing ribs 30 mid the outer edge 45 of the carpet layer 10 are inserted into the floor carpet 60 and are securely held therein against slippage.

The floor carpet 60 is installed on the floor panel 70 of the vehicle and has a fibrous structure so that the inner edge 25 of the pad 20, the reinforcing ribs 30 and the outer edge 45 of the carpet layer 10 can be easily inserted therein.

The lower end of the outer edge 45 of the carpet layer 10 is positioned deeper than the lower ends of the inner edge 25 of the pad 20 and the reinforcing ribs 30, so that the carpet layer 10 provided on the pad 20 looks as though it were flush with and integrally formed with the floor carpet 60. Therefore, since the outer edge 45 of the carpet layer 10 delimits the outermost periphery of the auxiliary mat 1 according to the present invention and the lower end of the outer edge 45 of the carpet layer 10 is inserted deepest into the floor carpet 60 of the vehicle, the carpet layer 10 formed on the upper part of the auxiliary mat 1 according to the present invention can appear to be substantially integrated with the floor carpet 60 on which the auxiliary mat 1 of the present invention is placed, to provide an appearance of flatness.

Further, due to the fact that the respective semicircular pattern frames 32 partially overlap with one another, it is possible to disperse and effectively resist external force. As a consequence, the portion of the auxiliary mat 1 that defines the concave groove 27 of auxiliary mat 1 is prevented from being deformed, so that the shape of the inner edge 25 can be stably maintained unchanged.

Moreover, as the lower ends 32a of the reinforcing ribs 30 are flush with the lower end 25a of the inner edge 25 of the pad 20, even when external force is applied to the portion of the auxiliary mat 1 that defines the concave groove 27 of auxiliary mat 1, the portion is prevented from being pressed downward and can maintain the sectional shape of the concave groove 27 of auxiliary mat 1 unchanged, as a result of which the shape of the inner edge 25 can also be maintained unchanged. Accordingly, the auxiliary mat 1 according to the present invention can be stably installed on the floor carpet 60 of the vehicle to be used without undergoing deformation of the configuration thereof. Furthermore, the reinforcing ribs 30 comprising semicircular pattern frame 32 and supporting frame 40 can be formed to have a quadrangular, triangular or angled sectional shape so that, when the auxiliary mat 1 is inserted into the floor carpet 60 of the vehicle, which is located thereunder, the auxiliary mat 1 can be stably held against slippage on the floor carpet 60.

As a consequence, in the present invention, since the reinforcing ribs 30 are integrally formed with the pad 20 in the concave groove 27 using the same material, it is not necessary to separately use any additional material, such as plastic or wood, so that the manufacturing cost can be decreased. By forming the reinforcing ribs 30 and the pad 20 using the same material, they can be simultaneously molded through a single process, so that the manufacturing cost can decrease and the price competitiveness of the auxiliary mat 1 can be improved.

In addition, in the present invention, as the semicircular pattern frames 32 constituting the reinforcing ribs 30 are projectedly formed, empty spaces are defined between the semicircular pattern frames 32, so that the auxiliary mat 1 can be decreased in weight. Therefore, since the load applied to the vehicle by the auxiliary mat 1 can be decreased, the fuel economy of the vehicle can be improved.

As is apparent from the above description, the auxiliary mat for a vehicle according to the present invention provides advantages in that, since reinforcing ribs are formed using a rubber material in a concave groove which is defined in the lower surface of the peripheral part of a pad bonded to a carpet layer, it is not necessary to use a separate material, such as plastic or wood, or to additionally conduct a separate manufacturing process. As a consequence, the manufacturing cost can be decreased, and the price competitiveness of the auxiliary mat can be improved.

Further, in the auxiliary mat for a vehicle according to the present invention, due to the fact that the reinforcing ribs are formed to have semicircular patterns, the auxiliary mat can be manufactured so that the weight thereof is decreased, so that the load imposed on a vehicle adopting the auxiliary mat according to the present invention can be decreased and thereby, the fuel economy of the vehicle can be improved.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. An auxiliary mat for a vehicle, comprising:
a carpet layer forming an upper surface of the auxiliary mat and having an outer edge portion;
a pad integrally formed on a portion of a lower surface of the carpet layer and having an inner edge projectedly formed to delimit a lower periphery of the pad and to be inserted into a floor carpet which is located under the pad wherein the pad defines a concave groove disposed between the outer edge portion of the carpet layer and the inner edge of the pad and partially enclosed by the carpet layer;
at least a reinforcing rib wherein a proximate end portion of the reinforcing ribs are positioned substantially near to the inner edge of the pad and a distal end portion of the reinforcing ribs integrally extends downward along the contour of the concave groove to the outer edge portion of the carpet layer to maintain a shape of the inner edge of the pad.

2. The auxiliary mat according to claim 1, wherein the reinforcing ribs have a structure in which they repeatedly project to define semicircular patterns.

3. The auxiliary mat according to claim 2, wherein the reinforcing ribs further comprises at least a supporting frame to support semicircular patterns.

4. The auxiliary mat according to claim 2 or 3, wherein lower ends of the reinforcing ribs are flush with a lower end of the inner edge of the pad.

5. The auxiliary mat according to claim 3, wherein the semicircular pattern frames of the reinforcing ribs are formed to have a structure in which they partially overlap one another.

6. The auxiliary mat according to claim 4, wherein a lower end of the outer edge of the carpet layer is positioned lower than the lower end of the inner edge of the pad so that the outer edge can be inserted deeper than the inner edge into the floor carpet, which is located under the pad.

7. The auxiliary mat according to claim 2, wherein the reinforcing ribs have a structure in which a height of the semicircular pattern frames is highest adjacent to the inner edge of the pad and gradually decreases toward the outer edge of the carpet layer.

8. The auxiliary mat according to claim 7, wherein the reinforcing ribs are formed to have a quadrangular, triangular or angled sectional shape to be inserted into the floor carpet and to be securely held therein against slippage.

9. The auxiliary mat according to claim 1, wherein the inner edge of the pad and the outer edge of the carpet layer have sharp corners.
